(19) United States
(12) Patent Application Publication
(10) Pub. No.: US 2015/0185630 A1
(43) Pub. Date: Jul. 2, 2015

(54) ELECTROPHOTOGRAPHIC PHOTOSENSITIVE MEMBER AND PROCESS CARTRIDGE, AND ELECTROPHOTOGRAPHIC APPARATUS

(71) Applicant: CANON KABUSHIKI KAISHA, Tokyo (JP)

(72) Inventors: Yota Ito, Mishima-shi (JP); Michiyo Sekiya, Atami-shi (JP); Nobuhiro Nakamura, Numazu-shi (JP); Atsushi Okuda, Yokohama-shi (JP); Kazunori Noguchi, Suntou-gun (JP); Kazuko Sakuma, Suntou-gun (JP)

(21) Appl. No.: 14/573,410

(22) Filed: Dec. 17, 2014

(30) Foreign Application Priority Data
Dec. 26, 2013 (JP) 2013-270564
Dec. 5, 2014 (JP) 2014-247188

(51) Int. Cl. G03G 15/00

(52) U.S. Cl. CPC G03G 5/0648

(57) ABSTRACT

In an electrophotographic photosensitive member, an undercoat layer contains a polymerized product of a composition including an electron transporting substance having a polymerizable functional group, and a crosslinking agent, and a metal oxide particle, and a mass ratio of the electron transporting substance in the composition to the metal oxide particle is 0.5 or more.

### BACKGROUND OF THE INVENTION

1. Field of the Invention

The present invention relates to an electrophotographic photosensitive member, and a process cartridge and an electrophotographic apparatus including the electrophotographic photosensitive member.

2. Description of the Related Art

As an electrophotographic photosensitive member mounted on a process cartridge or an electrophotographic apparatus, an electrophotographic photosensitive member containing an organic photoconductive substance is mainly used. The electrophotographic photosensitive member is good in film forming properties and can be produced by coating, and thus has an advantage of being high in productivity thereof.

The electrophotographic photosensitive member generally has a support, a charge generating layer formed on the support, and a hole transporting layer formed on the charge generating layer. Furthermore, an undercoat layer is often provided between the support and the charge generating layer for the purpose of suppressing hole injection from the support to the charge generating layer to suppress the occurrence of an image defect such as fogging or leak.

In order to achieve stability and environmental stability in repeated use of the electrophotographic photosensitive member, an undercoat layer is demanded in which charges are accumulated in small numbers in repeated use.

With respect to the undercoat layer in which charges are accumulated in small numbers, Japanese Patent Application Laid-Open No. H08-44096 describes a technique in which a metal oxide particle is dispersed in a polymerized product (curable resin) of a composition including a crosslinking agent and a resin having a polymerizable functional group. In the technique, enhancement in electron conductivity from a charge generating layer and the suppression of hole injection from a support are balanced, and stability and environmental stability in repeated use are improved.

In addition, Japanese Patent Application Laid-Open No. 2006-30698 describes a technique in which an electron transporting substance is added into an undercoat layer in order to improve stability and environmental stability in repeated use.

In recent years, a long-life electrophotographic photosensitive member has been demanded, and enhancements in stability of electrical properties and image quality in repeated use for a long period have been demanded.

In the undercoat layer in which the metal oxide particle is dispersed in the curable resin in Japanese Patent Application Laid-Open No. H08-44096, enhancement in electron conductivity from a charge generating layer and the suppression of hole injection from a support are in trade-off relation. Accordingly, satisfying such properties at the same time is not sufficient in terms of enhancements in stability of electrical properties and image quality in repeated use for a long period, and the technique has a room for improvement.

Also in the undercoat layer in which a metal oxide particle is dispersed in a composition of a curable resin and the electron transporting substance in Japanese Patent Application Laid-Open No. 2006-30698, the stability of electrical properties and image quality in repeated use for a long period cannot be improved in some cases, and the technique has a room for improvement.

Thus, the present inventors have made studies, and as a result, have found that the techniques disclosed in Japanese Patent Application Laid-Open No. H08-44096 and Japanese Patent Application Laid-Open No. 2006-30698 have a room for further improvement in stability of electrical properties in repeated use for a long period.

### SUMMARY OF THE INVENTION

The present invention is directed to providing an electrophotographic photosensitive member with a suppressed variation in electrical properties even in repeated use for a long period, and a process cartridge and an electrophotographic apparatus including the electrophotographic photosensitive member.

According to one aspect of the present invention, there is provided an electrophotographic photosensitive member including a support, an undercoat layer formed on the support, a charge generating layer formed directly on the undercoat layer, and a hole transporting layer formed on the charge generating layer, wherein the undercoat layer contains:

a polymerized product of a composition including an electron transporting substance having a polymerizable functional group, and a crosslinking agent; and

a metal oxide particle, and

a mass ratio of the electron transporting substance in the composition to the metal oxide particle is 0.5 or more.

According to another aspect of the present invention, there is provided a process cartridge integrally supporting the electrophotographic photosensitive member and at least one unit selected from the group consisting of a charging unit, a developing unit and a cleaning unit, the process cartridge being attachable to and detachable from a main body of an electrophotographic apparatus.

According to further aspect of the present invention, there is provided an electrophotographic apparatus including the electrophotographic photosensitive member, a charging unit, an exposing unit, a developing unit and a transfer unit.

The present invention can provide an electrophotographic photosensitive member with a suppressed variation in electrical properties even in repeated use for a long period, and a process cartridge and an electrophotographic apparatus including the electrophotographic photosensitive member.

Further features of the present invention will become apparent from the following description of exemplary embodiments with reference to the attached drawings.

### BRIEF DESCRIPTION OF THE DRAWINGS

FIG. 1 is a view illustrating one example of a layer structure of the electrophotographic photosensitive member.

FIG. 2 is a view illustrating a schematic configuration of an electrophotographic apparatus including a process cartridge provided with an electrophotographic photosensitive member.

### DESCRIPTION OF THE EMBODIMENTS

Preferred embodiments of the present invention will now be described in detail in accordance with the accompanying drawings.

In the present invention, an undercoat layer of an electrophotographic photosensitive member contains a polymerized product of a composition including an electron transporting substance having a polymerizable functional group, and a crosslinking agent, and a metal oxide particle, and a mass ratio of the electron transporting substance having a polymerizable functional group in the composition to the metal oxide particle is 0.5 or more.

The reason why the electrophotographic photosensitive member has a suppressed variation in electrical properties even in repeated use for a long period is presumed by the present inventors as follows.

It is considered that when the mass ratio of the electron transporting substance having a polymerizable functional group in the composition to the metal oxide particle is 0.5 or more, a main conductor that allows a charge carrier to pass in the undercoat layer is not the metal oxide particle but the electron transporting substance. This is presumed from the decrease in electron retention at the interface between the charge generating layer and the undercoat layer after exposure, and enhancement in electron conductivity in the undercoat layer, and is also presumed from the reduction in contact area of the metal oxide particle at the interface of the undercoat layer at the support side, and a significant suppression of hole injection to the undercoat layer. From the foregoing, it is considered that the charge carrier is mainly an electron and the undercoat layer serves as a conductor close to a semiconductor.

In the present invention, the mass ratio of the electron transporting substance having a polymerizable functional group in the composition to the metal oxide particle is 0.5 or more. If the mass ratio is less than 0.5, it is considered that the suppression of hole injection from the support is not sufficient and thereby causes the deterioration in charging properties, and thus the variation in electrical properties in repeated use for a long period easily occurs.

The polymerized product contained in the undercoat layer of the present invention is a polymerized product (cured product) of a composition including a crosslinking agent and an electron transporting substance having a polymerizable functional group. The crosslinking agent has a polymerizable functional group that can react with the polymerizable functional group of the electron transporting substance. Then, the polymerizable functional group of the crosslinking agent reacts with the polymerizable functional group of the electron transporting substance to form the polymerized product. Thus, when the charge generating layer is stacked, not only the electron transporting substance can be inhibited from being eluted, but also the electron transporting substance can be uniformly distributed in the undercoat layer, thereby forming a good electroconductive path for the electron transporting substance. The composition forming the polymerized product may further contain a resin having a polymerizable functional group, and even when the composition contains the resin, the same effect is obtained.

The electrophotographic photosensitive member of the present invention includes a support, a undercoat layer formed on the support, a charge generating layer formed directly on the undercoat layer, and a hole transporting layer formed on the charge generating layer.

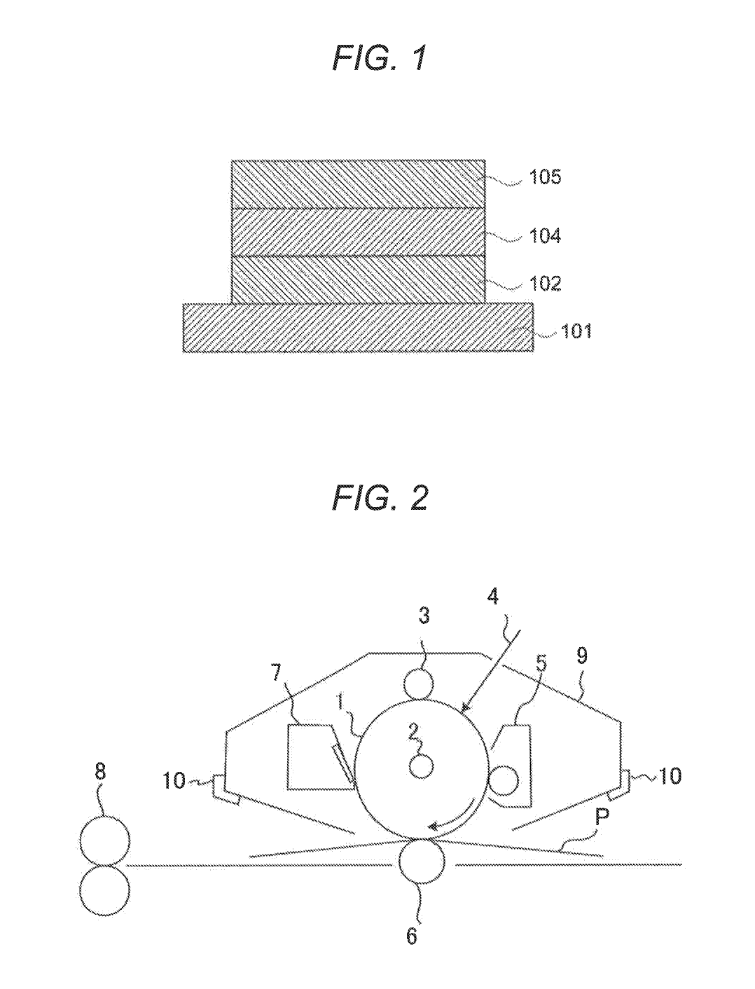

FIG. 1 is a view illustrating one example of a layer structure of the electrophotographic photosensitive member. In FIG. 1, the electrophotographic photosensitive member includes a support 101, an undercoat layer 102, a charge generating layer 104 and a hole transporting layer 105.

A cylindrical electrophotographic photosensitive member in which a charge generating layer and a hole transporting layer are formed on a cylindrical support is widely used as a general electrophotographic photosensitive member, but a belt-shaped or sheet-shaped electrophotographic photosensitive member can also be used.

[Undercoat Layer]

The undercoat layer is provided between the support and the charge generating layer.

The undercoat layer contains a metal oxide particle, and a polymerized product of a composition including an electron transporting substance having a polymerizable functional group, and a crosslinking agent. The mass ratio of the electron transporting substance in the composition to the metal oxide particle ((mass of electron transporting substance having a polymerizable functional group in composition)/(mass of metal oxide particle)) is 0.5 or more, preferably 0.5 or more and 100 or less, more preferably 1.0 or more and 10 or less, further preferably 1.0 or more and 5.0 or less.

Examples of the electron transporting substance include a quinone compound, an imide compound, a benzimidazole compound and a cyclopentadienylidene compound.

The polymerizable functional group of the electron transporting substance includes a hydroxy group, a thiol group, an amino group, a carboxyl group and a methoxy group. In particular, a hydroxy group and a carboxyl group can be adopted.

Hereinafter, specific examples of the electron transporting substance having a polymerizable functional group are shown below, but not limited thereto. Examples include a compound represented by any of the following formulae (A1) to (A11).

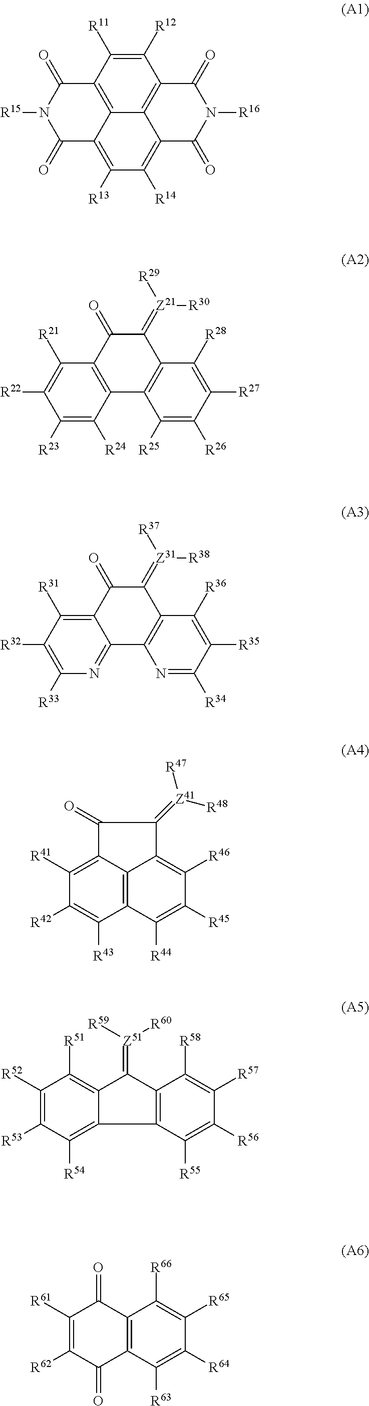

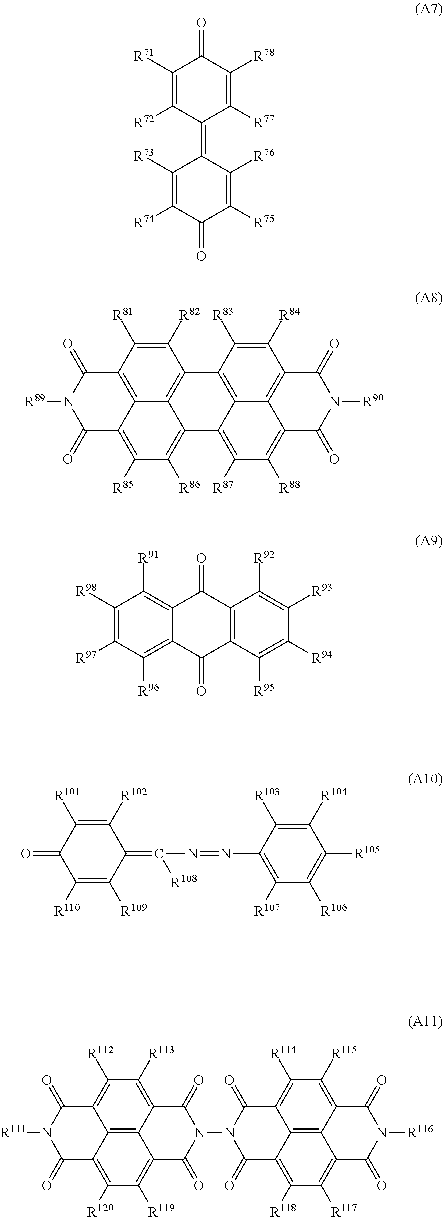

In the formulae (A1) to (A11), R¹¹ to R¹⁶, R²¹ to R³⁰, R³¹ to R³⁸, R⁴¹ to R⁴⁸, R⁵¹ to R⁶⁰, R⁶¹ to R⁶⁶, R⁷¹ to R⁷⁸, R⁸¹ to R⁹⁰, R⁹¹ to R⁹⁸, R¹⁰¹ to R¹¹⁰ and R¹¹¹ to R¹²⁰ each independently represent a monovalent group represented by the following formula (A), a hydrogen atom, a cyano group, a nitro group, a halogen atom, an alkoxycarbonyl group, a substituted or unsubstituted alkyl group, a substituted or unsubstituted aryl group, or a substituted or unsubstituted heterocyclic group, or a monovalent group derived by replacing one of CH₂ in the main chain of a substituted or unsubstituted alkyl group with O, S, NH or NR¹²¹ (R¹²¹ represents an alkyl group).

At least one of R¹¹ to R¹⁶, at least one of R²¹ to R³⁰, at least one of R³¹ to R³⁸, at least one of R⁴¹ to R⁴⁸, at least one of R⁵¹ to R⁶⁰, at least one of R⁶¹ to R⁶⁶, at least one of R⁷¹ to R⁷⁸, at least one of R⁸¹ to R⁹⁰, at least one of R⁹¹ to R⁹⁸, at least one of R¹⁰¹ to R¹¹⁰, and at least one of R¹¹¹ to R¹²⁰ have the monovalent group represented by the formula (A). The substituent of the substituted alkyl group is an alkyl group, aryl group, a halogen atom or an alkoxycarbonyl group. The substituent of the substituted aryl group and the substituent of the substituted heterocyclic group are each a halogen atom, a nitro group, a cyano group, an alkyl group, a halogen-substituted alkyl group or an alkoxy group. Z²¹, Z³¹, Z⁴¹ and Z⁵¹ each independently represent a carbon atom, a nitrogen atom or an oxygen atom. When Z²¹ represents an oxygen atom, R²⁹ and R³⁰ are not present, and when Z²¹ represents a nitrogen atom, R³⁰ is not present. When Z³¹ represents an oxygen atom, R³⁷ and R³⁸ are not present, and when Z³¹ represents a nitrogen atom, R³⁸ is not present. When Z⁴¹ represents an oxygen atom, R⁴⁷ and R⁴⁸ are not present, and when Z⁴¹ represents a nitrogen atom, R⁴⁸ is not present. When Z⁵¹ represents an oxygen atom, R⁵⁹ and R⁶⁰ are not present, and when Z⁵¹ represents a nitrogen atom, R⁶⁰ is not present.

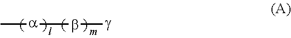

In the formula (A), at least one of α, β and γ represent a group having a polymerizable functional group, the polymerizable functional group is at least one group selected from the group consisting of a hydroxy group, a thiol group, an amino group, a carboxyl group and a methoxy group, l and m each independently denote 0 or 1, and the sum of l and m is 0 or more and 2 or less.

α represents a substituted or unsubstituted alkylene group having 1 to 6 atoms in the main chain, or a group derived by replacing one of CH₂ in the main chain of a substituted or unsubstituted alkylene group having 1 to 6 atoms in the main chain with O, S or NR¹²² (wherein R¹²² represents a hydrogen atom or an alkyl group.) The substituent of the alkylene group includes at least one group selected from the group consisting of an alkyl group having 1 to 6 carbon atoms, a benzyl group, an alkoxycarbonyl group, a phenyl group, a hydroxy group, a thiol group, an amino group, a carboxyl group and a methoxy group.

β represents a phenylene group, a phenylene group substituted with an alkyl group having 1 to 6 carbon atoms, a phenylene group substituted with a nitro group, a phenylene group substituted with a halogen group or a phenylene group substituted with an alkoxy group. Such groups may have at least one group selected from the group consisting of a hydroxy group, a thiol group, an amino group, a carboxyl group and a methoxy group, as the substituent.

γ represents a hydrogen atom, a substituted or unsubstituted alkyl group having 1 to 6 atoms in the main chain, or a monovalent group derived by replacing one of CH₂ in the main chain of a substituted or unsubstituted alkyl group having 1 to 6 atoms in the main chain with O, S or NR¹²³ (wherein R¹²³ represents a hydrogen atom or an alkyl group.). The substituent of the alkyl group includes at least one group selected from the group consisting of an alkyl group having 1 to 6 carbon atoms, a hydroxy group, a thiol group, an amino group, a carboxyl group and a methoxy group.

Specific examples (exemplary compounds) of the electron transporting substance having a polymerizable functional group are shown below, but not limited thereto. Herein, exemplary compounds in Tables 1 to 11 below are the compounds represented by the formulae (A1) to (A11), respectively. In Tables, Aa is represented by a structural formula as in the case of A. That is to say, A and Aa respectively represent the monovalent group represented by the formula (A), and specific examples of the monovalent group are shown in the columns of A and Aa. In Tables, when γ denotes “-”, γ represents a hydrogen atom, and the hydrogen atom of γ is represented, with being included in the structure shown in the column of α or β. In the following Tables, bonds indicated by a dot line are bound to each other.

TABLE 1

| Exemplary | | | | | | |
|---|---|---|---|---|---|---|
| compound | R¹¹ | R¹² | R¹³ | R¹⁴ | R¹⁵ | R¹⁶ |
| A101 | H | H | H | H | 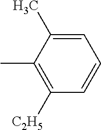 | A |
| A102 | H | H | H | H | 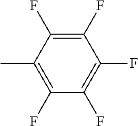 | A |
| A103 | H | H | H | H | 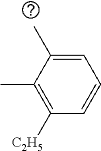 | A |
| A104 | H | H | H | H | 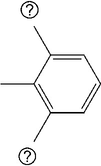 | A |
| A105 | H | H | H | H | 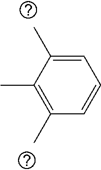 | A |
| A106 | H | H | H | H | A | A |
| A107 | H | H | H | H | A | A |
| A108 | H | H | H | H | 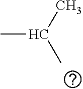 | A |
| A109 | H | H | H | H | 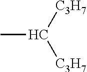 | A |
| A110 | H | H | H | H | 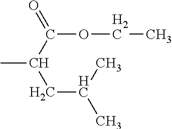 | A |
| A111 | H | H | H | H | 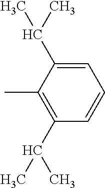 | A |
| A112 | H | H | H | H | 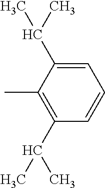 | A |
| A113 | H | H | H | H | A | A |
| A114 | H | H | H | H | A | A |
| A115 | H | H | H | H | A | Aa |
| A116 | H | H | H | H | A | Aa |
| A117 | H | H | H | H | A | Aa |
| A118 | H | H | H | H | A | Aa |
| A119 | H | H | H | H | A | Aa |
| A120 | H | H | H | H | A | A |

| Exemplary | A | | | Aa | | |
|---|---|---|---|---|---|---|
| compound | α | β | γ | α | β | γ |
| A101 | 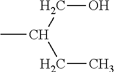 | — | — | — | — | — |
| A102 | 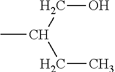 | — | — | — | — | — |
| A103 | — | 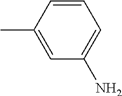 | — | — | — | — |
| A104 | — | 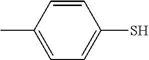 | — | — | — | — |
| A105 | 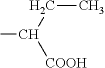 | — | — | — | — | — |
| A106 | 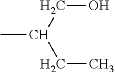 | — | — | — | — | — |
| A107 | 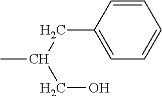 | — | — | — | — | — |
| A108 | 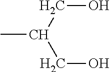 | — | — | — | — | — |
| A109 | 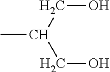 | — | — | — | — | — |
| A110 | 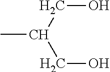 | — | — | — | — | — |
| A111 | 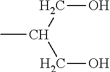 | — | — | — | — | — |
| A112 | 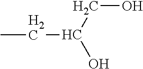 | — | — | — | — | — |
| A113 | 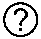 | — | — | — | — | — |
| A114 | 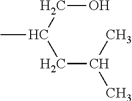 | — | — | — | — | — |
| A115 | — [symbol] —S— [symbol] —OH | — | — | 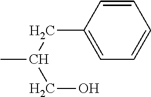 | — | — |
| A116 | 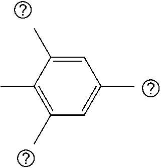 | — | — | 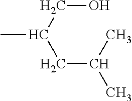 | — | — |
| A117 | — | 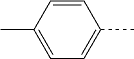 | 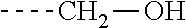 | 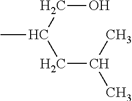 | — | — |
| A118 | — | 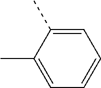 | 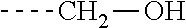 | 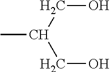 | — | — |
| A119 | 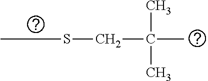 | — | — | 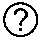 | — | — |
| A120 | 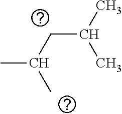 | — | — | — | — | — |

[symbol]

indicates data missing or illegible when filed

TABLE 2

| Exemplary | | | | | | | | | | | | A | | |
|---|---|---|---|---|---|---|---|---|---|---|---|---|---|---|
| compound | R²¹ | R²² | R²³ | R²⁴ | R²⁵ | R²⁶ | R²⁷ | R²⁸ | R²⁹ | R³⁰ | Z²¹ | α | β | γ |
| A201 | H | H | A | H | H | H | H | H | — | — | O | — | 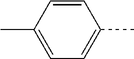 | 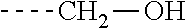 |
| A202 | H | H | H | H | H | H | H | H | A | — | N | — | 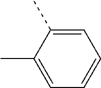 | 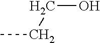 |
| A203 | H | H | 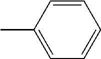 | H | H | 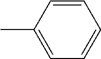 | H | H | A | — | N | — | 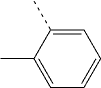 | 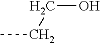 |
| A204 | H | H | 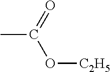 | H | H | 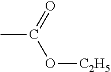 | H | H | A | — | N | — | 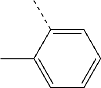 | 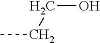 |
| A205 | H | H | A | H | H | A | H | H | — | — | O | — | 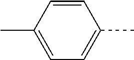 | 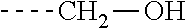 |
| A206 | H | A | H | H | H | H | A | H | — | — | O | — | 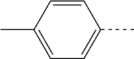 | 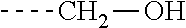 |

TABLE 3

| Exemplary | | | | | | | | | | A | | |
|---|---|---|---|---|---|---|---|---|---|---|---|---|
| compound | R³¹ | R³² | R³³ | R³⁴ | R³⁵ | R³⁶ | R³⁷ | R³⁸ | Z³¹ | α | β | γ |
| A301 | H | A | H | H | H | H | — | — | O | — | 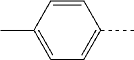 | 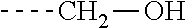 |
| A302 | H | H | H | H | H | H | A | — | N | — | 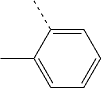 | 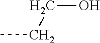 |
| A303 | H | H | H | H | H | H | A | — | N | 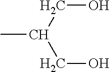 | — | — |
| A304 | H | H | Cl | Cl | H | H | A | — | N | — | 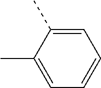 | 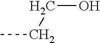 |
| A305 | H | A | H | H | A | H | CN | CN | C | — | 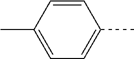 | 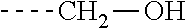 |

TABLE 4

| Exemplary | | | | | | | | | | A | | |
|---|---|---|---|---|---|---|---|---|---|---|---|---|
| compound | R⁴¹ | R⁴² | R⁴³ | R⁴⁴ | R⁴⁵ | R⁴⁶ | R⁴⁷ | R⁴⁸ | Z⁴¹ | α | β | γ |
| 401 | H | H | A | H | H | H | CN | CN | C | — | 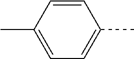 | 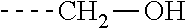 |
| A402 | H | H | H | H | H | H | A | — | N | — | 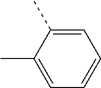 | 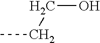 |
| A403 | H | H | A | A | H | H | CN | CN | C | — | 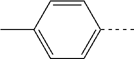 | 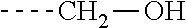 |
| A404 | H | H | A | A | H | H | CN | CN | C | — | 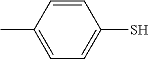 | — |
| A405 | H | H | A | A | H | H | — | — | O | — | 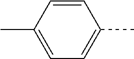 | 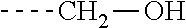 |

TABLE 5

| Exemplary | | | | | | | | | | | | A | | |
|---|---|---|---|---|---|---|---|---|---|---|---|---|---|---|
| compound | R⁵¹ | R⁵² | R⁵³ | R⁵⁴ | R⁵⁵ | R⁵⁶ | R⁵⁷ | R⁵⁸ | R⁵⁹ | R⁶⁰ | Z⁵¹ | α | β | γ |
| A501 | H | A | H | H | H | H | H | H | CN | CN | C | — | 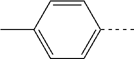 | 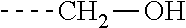 |
| A502 | H | NO₂ | H | H | NO₂ | H | NO₂ | H | A | — | N | — | 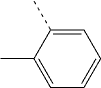 | 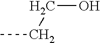 |
| A503 | H | A | H | H | H | H | A | H | CN | CN | C | 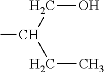 | — | — |
| A504 | H | H | A | H | H | A | H | H | CN | CN | C | — | 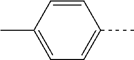 | 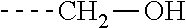 |

TABLE 6

| Exemplary | | | | | | | A | | |
|---|---|---|---|---|---|---|---|---|---|
| compound | R⁶¹ | R⁶² | R⁶³ | R⁶⁴ | R⁶⁵ | R⁶⁶ | α | β | γ |
| A601 | A | H | H | H | H | H | — | 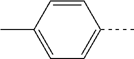 | 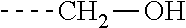 |
| A602 | A | H | H | H | H | H | — | 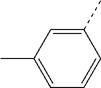 | 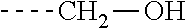 |
| A603 | A | H | H | H | H | H | 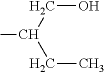 | — | — |
| A604 | A | A | H | H | H | H | — | 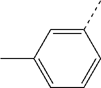 | 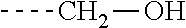 |
| A605 | A | A | H | H | H | H | 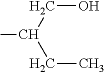 | — | — |

TABLE 7

| Exemplary | | | | | | | | | A | | |
|---|---|---|---|---|---|---|---|---|---|---|---|
| compound | R⁷¹ | R⁷² | R⁷³ | R⁷⁴ | R⁷⁵ | R⁷⁶ | R⁷⁷ | R⁷⁸ | α | β | γ |
| A701 | A | H | H | H | H | H | H | H | — | 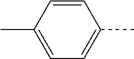 | 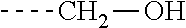 |
| A702 | A | H | H | H | H | H | H | H | 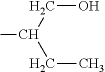 | — | — |
| A703 | A | H | H | H | A | H | H | H | — | 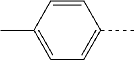 | 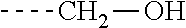 |
| A704 | A | H | H | H | Aa | H | H | H | 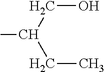 | — | — |
| A705 | A | H | H | H | Aa | H | H | H | — | 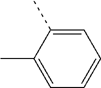 | 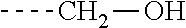 |

| Exemplary | Aa | | |
|---|---|---|---|
| compound | α | β | γ |
| A701 | — | — | — |
| A702 | — | — | — |
| A703 | — | — | — |
| A704 | — | 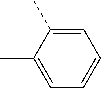 | 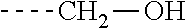 |
| A705 | 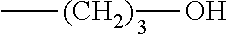 | — | — |

TABLE 8

| Exemplary | | | | | | | | | | | A | | |
|---|---|---|---|---|---|---|---|---|---|---|---|---|---|
| compound | R⁸¹ | R⁸² | R⁸³ | R⁸⁴ | R⁸⁵ | R⁸⁶ | R⁸⁷ | R⁸⁸ | R⁸⁹ | R⁹⁰ | α | β | γ |
| A801 | H | H | H | H | H | H | H | H | 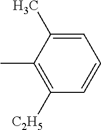 | A | 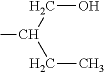 | — | — |
| A802 | H | H | H | H | H | H | H | H | 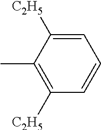 | A | — | 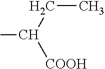 | — |
| A803 | H | CN | H | H | H | H | CN | H | 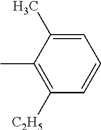 | A | 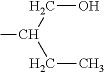 | — | — |
| A804 | H | H | H | H | H | H | H | H | A | A | 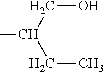 | — | — |
| A805 | H | H | H | H | H | H | H | H | A | A | — | 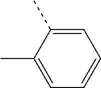 | 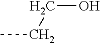 |

TABLE 9

| Exemplary | | | | | | | | | A | | |
|---|---|---|---|---|---|---|---|---|---|---|---|
| compound | R⁹¹ | R⁹² | R⁹³ | R⁹⁴ | R⁹⁵ | R⁹⁶ | R⁹⁷ | R⁹⁸ | α | β | γ |
| A901 | A | H | H | H | H | H | H | H | —CH₂—OH | — | — |
| A902 | A | H | H | H | H | H | H | H | 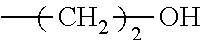 | — | — |
| A903 | H | H | H | H | H | H | H | A | —CH₂—OH | — | — |
| A904 | H | H | H | H | H | H | H | A | 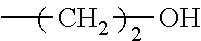 | — | — |
| A905 | H | CN | H | H | H | H | CN | A | — | 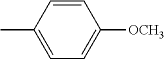 | — |
| A906 | A | A | H | NO₂ | H | H | NO₂ | H | 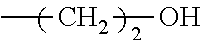 | — | — |
| A907 | H | A | A | H | H | H | H | H | —CH₂—OH | — | — |

TABLE 10

| Exemplary | | | | | | | | | |
|---|---|---|---|---|---|---|---|---|---|
| compound | R¹⁰¹ | R¹⁰² | R¹⁰³ | R¹⁰⁴ | R¹⁰⁵ | R¹⁰⁶ | R¹⁰⁷ | R¹⁰⁸ | R¹⁰⁹ |
| A1001 | 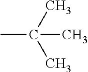 | H | H | H | A | H | H | H | H |
| A1002 | 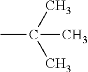 | H | H | H | A | H | H | H | H |
| A1003 | 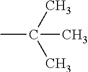 | H | H | H | A | H | H | H | H |
| A1004 | 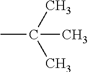 | H | H | H | A | H | H | H | H |
| A1005 | 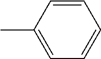 | H | H | H | A | H | H | H | H |

| Exemplary | | A | | |
|---|---|---|---|---|
| compound | R¹¹⁰ | α | β | γ |
| A1001 | 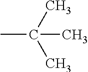 | —CH₂—OH | — | — |
| A1002 | 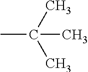 | — | 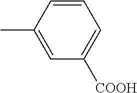 | — |
| A1003 | 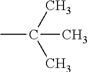 | — | 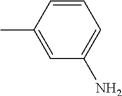 | — |
| A1004 | 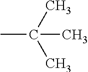 | — | 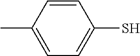 | — |
| A1005 | 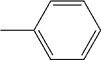 | —CH₂—OH | — | — |

TABLE 11

| Exemplary | | | | | | | | | | |
|---|---|---|---|---|---|---|---|---|---|---|
| compound | R¹¹¹ | R¹¹² | R¹¹³ | R¹¹⁴ | R¹¹⁵ | R¹¹⁶ | R¹¹⁷ | R¹¹⁸ | R¹¹⁹ | R¹²⁰ |
| A1101 | A | H | H | H | H | A | H | H | H | H |
| A1102 | A | H | H | H | H | A | H | H | H | H |
| A1103 | A | H | H | H | H | A | H | H | H | H |
| A1104 | A | H | H | H | H | 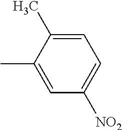 | H | H | H | H |
| A1105 | A | H | H | H | H | 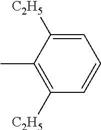 | H | H | H | H |

| Exemplary | A | | |
|---|---|---|---|
| compound | α | β | γ |
| A1101 | 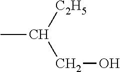 | — | — |
| A1102 | 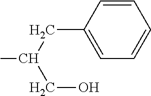 | — | — |
| A1103 | — | 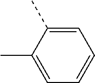 | 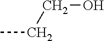 |
| A1104 | 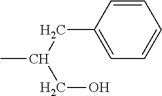 | — | — |
| A1105 | 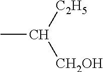 | — | — |

A derivative having a structure of any of (A2) to (A6) and (A9) (derivative of electron transporting substance) can be purchased from Tokyo Chemical Industry Co., Ltd., Sigma-Aldrich Japan K.K., or Johnson Matthey Japan G.K. A derivative having a structure of (A1) can be synthesized by a reaction of naphthalenetetracarboxylic dianhydride that can be purchased from Tokyo Chemical Industry Co., Ltd., Sigma-Aldrich Japan K.K. or Johnson Matthey Japan G.K. with a monoamine derivative. A derivative having a structure of (A7) can be synthesized by using a phenol derivative that can be purchased from Tokyo Chemical Industry Co., Ltd. or Sigma-Aldrich Japan K.K. as a raw material. A derivative having a structure of (A8) can be synthesized by a reaction of perylenetetracarboxylic dianhydride that can be purchased from Tokyo Chemical Industry Co., Ltd. or Sigma-Aldrich Japan K.K. with a monoamine derivative. A derivative having a structure of (A10) can be synthesized by using a known synthesis method described in, for example, Japanese Patent Publication No. 3717320 to oxidize a phenol derivative having a hydrazone structure by a proper oxidant such as potassium permanganate in an organic solvent. A derivative having a structure of (A11) can be synthesized by a reaction of naphthalenetetracarboxylic dianhydride that can be purchased from Tokyo Chemical Industry Co., Ltd., Sigma-Aldrich Japan K.K. or Johnson Matthey Japan G.K. with a monoamine derivative and hydrazine.

A compound represented by any of (A1) to (A11) has a polymerizable functional group (hydroxy group, thiol group, amino group, carboxyl group and methoxy group) polymerizable with the crosslinking agent. Examples of the method for introducing the polymerizable functional group to a derivative having a structure of any of (A1) to (A11) to synthesize the compound represented by any of (A1) to (A11) include the following methods: a method including synthesizing the derivative having a structure of any of (A1) to (A11), and then directly introducing the polymerizable functional group; and a method including synthesizing the derivative having a structure of any of (A1) to (A11), and then introducing a structure having a functional group that can serve as the polymerizable functional group or a precursor of the polymerizable functional group. Examples of this method include a method including performing a cross-coupling reaction of, for example, a halide of the derivative having a structure of any of (A1) to (A11) with use of, for example, a palladium catalyst and a base to introduce an aryl group having the functional group; a method including performing a cross-coupling reaction of a halide of the derivative having a structure of any of (A1) to (A11) with use of a FeCl₃ catalyst and a base to introduce an alkyl group having the functional group; and a method including performing lithiation of a halide of the derivative having a structure of any of (A1) to (A11), and then allowing an epoxy compound and CO₂ to act to thereby introduce a hydroxyalkyl group and a carboxyl group.

The electron transporting substance having a polymerizable functional group can have two or more polymerizable functional groups in the same molecule in order to form an undercoat layer having a strong network structure insoluble in a solvent.

The content of the electron transporting substance having a polymerizable functional group is can be 20% by mass or more based on the total solid content of an undercoat layer coating liquid. When the content is 20% by mass or more, the effect of the present invention, in which the undercoat layer is allowed to function as a conductor close to a semiconductor, can be sufficiently exerted. The content is more preferably 20% by mass or more and 40% by mass or less.

[Crosslinking Agent]

Then, the crosslinking agent is described. As the crosslinking agent, a compound can be used which can be polymerized (cured) or crosslinked with the electron transporting substance having a polymerizable functional group. Specifically, compounds described in “Crosslinking Agent Handbook”, edited by Shinzo Yamashita and Tosuke Kaneko, published by Taiseisha Ltd. (1981), and the like can be used.

The crosslinking agent includes a crosslinking agent having an isocyanate group, an alkylol group, an epoxy group, a carboxyl group or an oxazoline group. In particular, an isocyanate compound having an isocyanate group or a block isocyanate group, or an amine compound having an alkylol group or an alkyletherified alkylol group can be adopted.

The isocyanate compound can be an isocyanate compound having 2 to 6 isocyanate groups or block isocyanate groups. The isocyanate compound includes isocyanurate modifications, biuret modifications, allophanate modifications and trimethylolpropane or pentaerythritol adduct modifications of diisocyanate, such as tolylene diisocyanate, hexamethylene diisocyanate, dicyclohexylmethane diisocyanate, naphthalene diisocyanate, diphenylmethane diisocyanate, isophorone diisocyanate, xylylene diisocyanate, 2,2,4-trimethylhexamethylene diisocyanate, methyl-2,6-diisocyanate hexanoate and norbornane diisocyanate in addition to triisocyanatobenzene, triisocyanatomethylbenzene, triphenylmethane triisocyanate, lysine triisocyanate. In particular, isocyanurate modifications can be adopted. The molecular weight of the isocyanate compound can be 200 to 1,300.

The amine compound can be an amine compound having 2 to 6 alkylol groups or alkyletherified alkylol groups. Examples include melamine derivatives such as hexamethylol melamine, pentamethylol melamine and tetramethylol melamine, guanamine derivatives such as tetramethylol benzoguanamine and tetramethylol cyclohexylguanamine, and urea derivatives such as dimethylol dihydroxyethylene urea, tetramethylol acetylene diurea and tetramethylol urea. In particular, melamine derivatives can be adopted. The molecular weight of the amine compound is preferably 150 to 1,000, more preferably 180 to 560.

The solvent for use in an undercoat layer coating liquid includes alcohol solvents, ether solvents, ester solvents, ketone solvents, sulfoxide solvents or aromatic hydrocarbon solvents.

[Metal Oxide Particle]

Then, the metal oxide particle is described. Examples of the metal oxide particle include particles of zinc oxide, lead white, aluminum oxide, indium oxide, silicon oxide, zirconium oxide, tin oxide, titanium oxide, magnesium oxide, antimony oxide, bismuth oxide, indium oxide doped with tin, tin oxide doped with antimony or tantalum, and zirconium oxide. Among the particles, particles of zinc oxide, titanium oxide and tin oxide can be adopted.

The content of the metal oxide particle based on the total mass of the undercoat layer can be 5% by mass or more and 50% by mass or less. When the content is in the range, leak resistance against a local high-current is good.

When the content of the metal oxide particle is less than 5% by mass, the mass ratio of the electron transporting substance having a polymerizable functional group in the composition including the electron transporting substance having a polymerizable functional group and the crosslinking agent, to the metal oxide particle, can be 11 or more and 100 or less from the same reason. When the content is in the range, the effect of suppressing an interference fringe is high.

When the undercoat layer coating liquid is prepared, the metal oxide particle may also be subjected to a surface treatment with a silane coupling agent or the like for the purpose of enhancement in dispersibility of the metal oxide particle.

[Resin]

Then, the resin is described. The resin may be contained in the undercoat layer for the purposes of the improvement in film forming properties, and the improvement in adhesiveness of the undercoat layer with the support and the charge generating layer.

Examples of the resin include an acetal resin such as a butyral resin, a polyolefin resin, a polyester resin, a polyether resin, a polyamide resin, an alkyd resin and a polyvinyl resin. In particular, a thermoplastic resin having a polymerizable functional group that can react with the crosslinking agent can be used.

The thermoplastic resin having a polymerizable functional group can be a thermoplastic resin having a structural unit represented by the following formula (D).

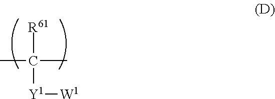

In the formula (D), R⁶¹ represents a hydrogen atom or an alkyl group, Y¹ represents a single bond, an alkylene group or a phenylene group, and W¹ represents a hydroxy group, a thiol group, an amino group, a carboxyl group or a methoxy group.

Examples of the thermoplastic resin having the structural unit represented by the formula (D) include an acetal resin, a polyolefin resin, a polyester resin, a polyether resin and a polyamide resin. Such resins have the following characteristic structure, in addition to the structural unit represented by the formula (D). The characteristic structure is shown in (E-1) to (E-6) below. (E-1) is a structural unit of an acetal resin, (E-2) is a structural unit of a polyolefin resin, (E-3) is a structural unit of a polyester resin, (E-4) is a structural unit of a polyether resin and (E-5) is a structural unit of a polyamide resin. (E-6) is a structural unit of a cellulose resin.

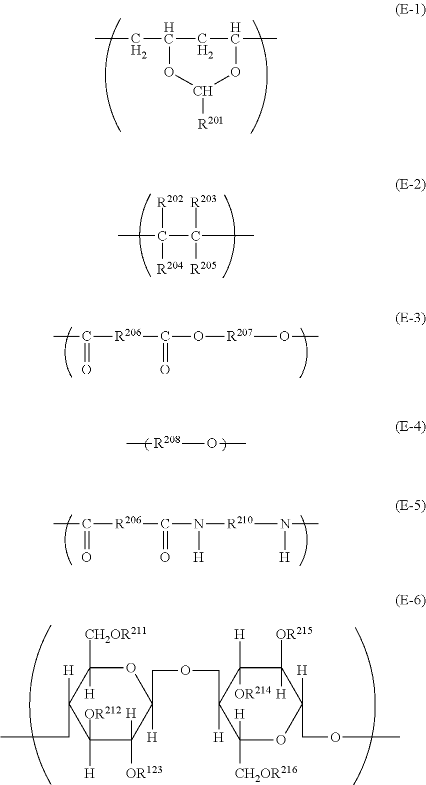

In the formulae (E-1) to (E-6), R²⁰¹ to R²⁰⁵ each independently represent a substituted or unsubstituted alkyl group, or a substituted or unsubstituted aryl group. R²⁰⁶ to R²¹⁰ each independently represent a substituted or unsubstituted alkylene group, or a substituted or unsubstituted arylene group. For example, when R²⁰¹ represents C₃H₇, the acetal resin is made of butyral. R²¹¹ to R²¹⁶ represent an acetyl group, a hydroxyethyl group, a hydroxypropyl group or a hydrogen atom.

The resin having the structural unit represented by the formula (D) (hereinafter, also referred to as “resin D”) can be obtained by polymerizing a monomer having a polymerizable functional group, which can be purchased from, for example, Sigma-Aldrich Japan K.K. or Tokyo Chemical Industry Co., Ltd.

The resin D can also be generally purchased. Examples of the resin that can be purchased include polyether polyol resins such as AQD-457 and AQD-473 produced by Nippon Polyurethane Industry Co., Ltd., and Sunnix GP-400 and GP-700 produced by Sanyo Chemical Industries, Ltd.; polyester polyol resins such as Phthalkid W2343 produced by Hitachi Chemical Co., Ltd., Watersol 5-118 as well as CD-520 and Beckolite M-6402-50 and M-6201-40IM produced by DIC Corporation, Haridip WH-1188 produced by Harima Chemicals Group, Inc., and ES3604 and ES6538 produced by Japan Upica Co., Ltd.; polyacryl polyol resins such as Burnock WE-300 and WE-304 produced by DIC Corporation; polyvinyl alcohol resins such as Kuraray Poval PVA-203 produced by Kuraray Co., Ltd.; polyvinyl acetal resins such as BX-1, BM-1, KS-1 and KS-5 produced by Sekisui Chemical Co., Ltd.; polyamide resins such as Toresin FS-350 produced by Nagase ChemteX Corporation; carboxyl group-containing resins such as Aqualic produced by Nippon Shokubai Co., Ltd. and Finelex SG2000 produced by Namariichi Co., Ltd.; polyamine resins such as Rackamide produced by DIC Corporation; and polythiol resins such as QE-340M produced by Toray Industries, Inc. In particular, polyvinyl acetal resins and polyester polyol resins can be adopted from the viewpoints of polymerizing property and the uniformity of an undercoat layer.

The weight average molecular weight of the resin D can be in the range from 5,000 to 400,000.

The undercoat layer in the present invention may contain additives such as an organic particle and a leveling agent in addition to the above compounds, in order to improve the film forming properties and electrical properties of the undercoat layer. Herein, the content of the additives in the undercoat layer can be 20% by mass or less based on the total mass of the undercoat layer.

[Support]

The support can be a support having electroconductivity (electroconductive support), and for example, a support made of a metal such as aluminum, iron, nickel, copper or gold, or an alloy of such metals can be used. Examples include a support in which a thin film made of a metal such as aluminum, chromium, silver or gold, or a thin film made of an electroconductive material such as indium oxide or tin oxide is formed on an insulating support made of a polyester resin, a polycarbonate resin, a polyimide resin, glass or the like. The surface of the support may be subjected to an electrochemical treatment such as anodization, a wet horning treatment, a blasting treatment, a cutting treatment or the like for the purposes of the improvement in electrical properties and the suppression of an interference fringe.

An electroconductive layer may also be provided between the support and the undercoat layer. The electroconductive layer is obtained by dispersing an electroconductive particle in the resin to provide an electroconductive layer coating liquid, forming a coating film of the coating liquid on the support, and drying the film.

[Charge Generating Layer]

The charge generating layer is provided directly on the undercoat layer.

The charge generating substance for use in the charge generating layer includes an azo pigment, a perylene pigment, an anthraquinone derivative, an anthanthrone derivative, a dibenzpyrenequinone derivative, a pyranthrone derivative, a violanthrone derivative, an isoviolanthrone derivative, an indigo derivative, a thioindigo derivative, phthalocyanine pigments such as metal phthalocyanine and non-metal phthalocyanine, and a bisbenzimidazole derivative. In particular, an azo pigment and a phthalocyanine pigment can be adopted. With respect to the phthalocyanine pigment, oxytitanium phthalocyanine, chlorogallium phthalocyanine and hydroxy gallium phthalocyanine can be adopted.

Examples of the binder resin for use in the charge generating layer include polymers and copolymers of vinyl compounds such as styrene, vinyl acetate, vinyl chloride, acrylate, methacrylate, vinylidene fluoride and trifluoroethylene, and a polyvinyl alcohol resin, a polyvinyl acetal resin, a polycarbonate resin, a polyester resin, a polysulfone resin, a polyphenylene oxide resin, a polyurethane resin, a cellulose resin, a phenol resin, a melamine resin, a silicone resin and an epoxy resin. In particular, a polyester resin, a polycarbonate resin and a polyvinyl acetal resin are preferable, in particular, a polyvinyl acetal resin is more preferable.

The mass ratio of the charge generating substance to the binder resin in the charge generating layer (charge generating substance/binder resin) is preferably in the range from 10/1 to 1/10, more preferably in the range from 5/1 to 1/5. The thickness of the charge generating layer can be 0.05 μm or more and 5 μm or less. The solvent for use in the charge generating layer coating liquid includes alcohol solvents, sulfoxide solvents, ketone solvents, ether solvents, ester solvents or aromatic hydrocarbon solvents.

[Hole Transporting Layer]

The hole transporting layer is provided on the charge generating layer.

The hole transporting substance for use in the hole transporting layer includes such as a polycyclic aromatic compound, a heterocyclic compound, a hydrazone compound, a styryl compound, a benzidine compound, a triarylamine compound and triphenylamine. Alternatively, the hole transporting substance includes polymers having groups derived from those compounds in the main chain or the side chain.

The binder resin for use in the hole transporting layer include such as a polyester resin, a polycarbonate resin, a polymethacrylate resin, a polyarylate resin, a polysulfone resin and a polystyrene resin. In particular, a polycarbonate resin and a polyarylate resin can be adopted. The weight average molecular weight of the binder resin can be in the range from 10,000 to 300,000.

The mass ratio of the hole transporting substance to the binder resin in the hole transporting layer (hole transporting substance/binder resin) is preferably in the range from 10/5 to 5/10, more preferably in the range from 10/8 to 6/10. The thickness of the hole transporting layer is preferably 5 μm or more and 40 μm or less.

The solvent for use in a hole transporting layer coating liquid includes such as alcohol solvents, sulfoxide solvents, ketone solvents, ether solvents, ester solvents or aromatic hydrocarbon solvents.

A protective layer (surface protective layer) containing an electroconductive particle or the hole transporting substance, and the binder resin may also be provided on the hole transporting layer. The protective layer can further contain an additive such as a lubricant. The binder resin itself of the protective layer may have electroconductivity and hole transporting properties, and in such a case, the protective layer may contain no electroconductive particle and no hole transporting substance, in addition to the binder resin. The binder resin of the protective layer may be a thermoplastic resin, or a curable resin to be cured by heat, light, radiation (such as electron beam) or the like.

The method for forming each of the layers forming the electrophotographic photosensitive member, such as the electroconductive layer, the undercoat layer, the charge generating layer and the hole transporting layer, can be the following method; namely, a method including dissolving and/or dispersing a material for forming each layer in each solvent to provide a coating liquid, forming a coating film by coating with the coating liquid, and drying and/or curing the resulting coating film. Examples of the coating method of the coating liquid include a dip coating method, a spray coating method, a curtain coating method, a spin coating method and a ring method. In particular, a dip coating method can be adopted from the viewpoints of efficiency and productivity.

[Process Cartridge and Electrophotographic Apparatus]

FIG. 2 illustrates one example of a schematic configuration of an electrophotographic apparatus having a process cartridge provided with the electrophotographic photosensitive member of the present invention.

The electrophotographic apparatus illustrated in FIG. 2 has a cylindrical electrophotographic photosensitive member 1 which is rotatably driven at a predetermined peripheral velocity around a shift 2 in the arrow direction. The surface (periphery) of the electrophotographic photosensitive member 1 rotatably driven is uniformly charged at a predetermined positive or negative potential by a charging unit 3 (primary charging unit: charging roller or the like). Then, the surface of the electrophotographic photosensitive member 1, uniformly charged, is exposed to exposure light (image exposure light) 4 from an exposing unit (not illustrated) such as slit exposure or laser beam scanning exposure. Thus, an electrostatic latent image corresponding to an intended image is sequentially formed on the surface of the electrophotographic photosensitive member 1.

Then, the electrostatic latent image formed on the surface of the electrophotographic photosensitive member 1 is developed by a toner included in a developer of a developing unit 5 to form a toner image. Then, the toner image formed and supported on the surface of the electrophotographic photosensitive member 1 is sequentially transferred to a transfer material (paper or the like) P by a transfer bias from a transfer unit (transfer roller or the like) 6. Herein, the transfer material P is taken out from a transfer material feeding unit (not illustrated) and fed to a gap (abutting portion) between the electrophotographic photosensitive member 1 and the transfer unit 6 in synchronization with rotation of the electrophotographic photosensitive member 1.

The transfer material P to which the toner image is transferred is separated from the surface of the electrophotographic photosensitive member 1, introduced to a fixing unit 8 to be subjected to image fixing, and discharged as an image-formed product (print, copy) outside the apparatus.

The surface of the electrophotographic photosensitive member 1 after the toner image is transferred is subjected to removal of a transfer residual developer (transfer residual toner) by a cleaning unit (cleaning blade or the like) 7 to be cleaned. Then, the surface of the electrophotographic photosensitive member 1, cleaned, is subjected to an antistatic treatment by pre-exposure (not illustrated) from a pre-exposing unit (not illustrated), and then repeatedly used for image formation. Herein, when the charging unit 3 is a contact charging unit using a charging roller or the like, as illustrated in FIG. 2, such pre-exposure is not necessarily required.

Among elements including such as the electrophotographic photosensitive member 1, the charging unit 3, the developing unit 5 and the cleaning unit 7, a plurality of elements are selected, accommodated in a container, and integrally supported as a process cartridge. The process cartridge can be configured to be attachable to and detachable from the main body of an electrophotographic apparatus such as a copier or a laser beam printer. In FIG. 2, the electrophotographic photosensitive member 1 is integrally supported together with the charging unit 3, the developing unit 5 and the cleaning unit 7 to be formed into a cartridge, and the cartridge is used as a process cartridge 9 attachable to and detachable from the main body of the electrophotographic apparatus using a guide unit 10 such as a rail for the main body of the electrophotographic apparatus.

### EXAMPLES

Hereinafter, the present invention is described in more detail with reference to Examples and Comparative Examples, but the present invention is not limited to the following Examples at all. Herein, “part(s)” in Examples and Comparative Examples means “part(s) by mass”.

### Example 1

An aluminum cylinder having a length of 260.5 mm and a diameter of 30 mm (JIS-A3003, aluminum alloy) was subjected to a horning treatment, and used as a support (electroconductive support).

Then, 100 parts of a zinc oxide particle (average particle size: 70 nm, specific surface area: 15 m²/g, produced by Tayca) was mixed with 500 parts of toluene under stirring. As a surface treatment agent, 1.25 parts of N-2-(aminoethyl)-3-aminopropyltrimethoxysilane (trade name: KBM603, produced by Shin-Etsu Chemical Co., Ltd.) was added thereto and mixed therewith for 4 hours under stirring. Thereafter, toluene was distilled off under reduced pressure, and the resultant was dried at 120° C. for 3 hours to provide a zinc oxide particle subjected to a surface treatment with a silane coupling agent.

Five parts of the zinc oxide particle subjected to a surface treatment with a silane coupling agent,

10 parts of electron transporting substance (A117) having a polymerizable functional group,
14.2 parts of a crosslinking agent having a block isocyanate group represented by the following formula (6),
1.5 parts of a butyral resin (trade name: Eslec BX-1, produced by Sekisui Chemical Co., Ltd.), and
0.2 parts of dioctyl tin dilaurate were added to a mixed solvent of 113 parts of tetrahydrofuran and 113 parts of 1-methoxy-2-propanol to prepare a dispersion liquid.

The dispersion liquid was subjected to a dispersion treatment in a vertical sand mill with glass beads having an average particle size of 1.0 mm for 4 hours. After the dispersion treatment, 3 parts of a silicone resin particle (trade name: Tospearl 145, produced by Momentive Performance Materials Inc.) was added to the resulting dispersion liquid and stirred to thereby prepare an undercoat layer coating liquid. The support was dip-coated with the undercoat layer coating liquid, and the resulting coating film was heated and cured at 160° C. for 30 minutes to thereby form an undercoat layer that was a cured film having a thickness of 10 μm (film having a polymerized product).

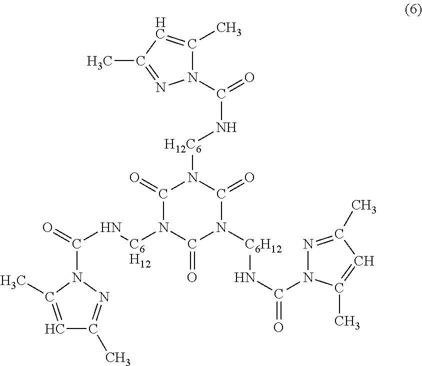

Then, a hydroxy gallium phthalocyanine crystal (charge generating substance) having a crystal form exhibiting peaks at Bragg angles (2θ±0.2°) of 7.5°, 9.9°, 12.5°, 16.3°, 18.6°, 25.1° and 28.3° in CuKα characteristic X-ray diffraction was prepared. A sand mill with glass beads having a diameter of 1.0 mm was loaded with 10 parts of the hydroxy gallium phthalocyanine crystal, 5 parts of a butyral resin (trade name: Eslec BX-1, produced by Sekisui Chemical Co., Ltd.) and 260 parts of cyclohexanone, and the resultant was subjected to a dispersion treatment for 1.5 hours. Then, 240 parts of ethyl acetate was added thereto to prepare a charge generating layer coating liquid. The undercoat layer was dip-coated with the charge generating layer coating liquid, and the resulting coating film was dried at 95° C. for 10 minutes to thereby form a charge generating layer having a thickness of 0.18 μm.

Then, 7 parts of an amine compound represented by the following formula (7) (hole transporting substance), and

10 parts of a polyarylate resin having a structural unit represented by the following formula (3-1) and a structural unit represented by the following formula (3-2) in a ratio of 5/5, and having a weight average molecular weight of 100,000,
were dissolved in a mixed solvent of 30 parts of dimethoxymethane and 70 parts of chlorobenzene to thereby prepare a hole transporting layer coating liquid. The charge generating layer was dip-coated with the hole transporting layer coating liquid, and the resulting coating film was dried at 120° C. for 60 minutes to thereby form a hole transporting layer having a thickness of 15 μm.

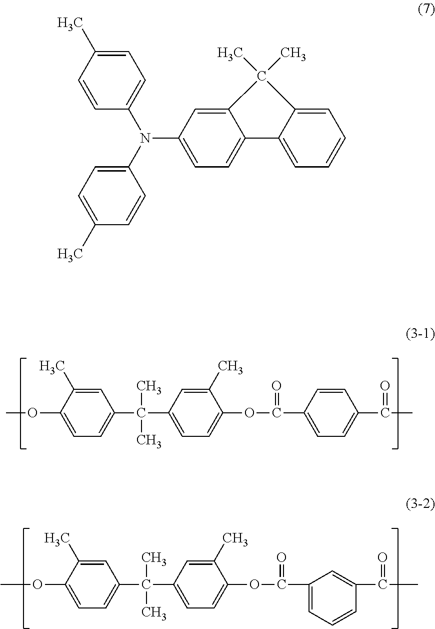

As described above, an electrophotographic photosensitive member having an electroconductive layer, an undercoat layer, a charge generating layer and a hole transporting layer on a support was produced.

(Evaluation of Fluctuation in Potential)

The electrophotographic photosensitive member produced in Example 1 was mounted to a laser beam printer manufactured by Canon Inc. (trade name: LBP-2510), which was altered, and the surface potential was determined, under an environment of a temperature of 15° C. and a humidity of 10% RH. The detail is as follows.

The surface potential of the electrophotographic photosensitive member was determined as follows: first, a cyan process cartridge for the laser beam printer was altered and a potential probe (trade name: model 6000B-8, manufactured by Trek Japan) was placed at a development position, and thereafter, the potential at the center portion of the electrophotographic photosensitive member was measured using a surface potential meter (trade name: model 344, manufactured by Trek Japan). The amount of light in image exposure was set so that with respect to the surface potential of the electrophotographic photosensitive member, the initial dark potential (Vd₀) was −600 V and the initial light potential (Vl₀) was −150 V. The repeated-use test was performed in which an image was continuously output for 10,000 sheets in the amount of exposure light set in such a state (the state where the potential probe was arranged at the portion of a development machine), and the dark potential (Vd_{f}) and the light potential (Vl_{f}) after repeated use were measured. The fluctuations in dark potential and light potential, ΔVd=Vd_{f}−Vd₀ and ΔVl=Vl_{f}−Vl₀, respectively, are shown in Table 12.

### Example 2

An electrophotographic photosensitive member was produced and the fluctuations in potentials thereof were determined in the same manner as in Example 1 except that the amounts by mass of the crosslinking agent and the resin used in the undercoat layer coating liquid in Example 1 were changed to 16.8 parts by mass and 3 parts by mass, respectively. The results are shown in Table 12.

### Example 3

An electrophotographic photosensitive member was produced and the fluctuations in potentials thereof were determined in the same manner as in Example 1 except that the amounts by mass of the crosslinking agent and the resin used in the undercoat layer coating liquid in Example 1 were changed to 19.4 parts by mass and 4.5 parts by mass, respectively. The results are shown in Table 12.

### Example 4

An electrophotographic photosensitive member was produced and the fluctuations in potentials thereof were determined in the same manner as in Example 1 except that the amounts by mass of the crosslinking agent and the resin used in the undercoat layer coating liquid in Example 1 were changed to 22 parts by mass and 6 parts by mass, respectively. The results are shown in Table 12.

### Example 5

An electrophotographic photosensitive member was produced and the fluctuations in potentials thereof were determined in the same manner as in Example 1 except that the amounts by mass of the crosslinking agent and the resin used in the undercoat layer coating liquid in Example 1 were changed to 24.6 parts by mass and 7.5 parts by mass, respectively. The results are shown in Table 12.

### Example 6

An electrophotographic photosensitive member was produced and the fluctuations in potentials thereof were determined in the same manner as in Example 2 except that the amount by mass of the zinc oxide particle subjected to a surface treatment with a silane coupling agent, used in the undercoat layer coating liquid in Example 2, was changed to 2.5 parts by mass, and both the amounts by mass of tetrahydrofuran and 1-methoxy-2-propanol were changed to 89 parts by mass. The results are shown in Table 12.

### Example 7

An electrophotographic photosensitive member was produced and the fluctuations in potentials thereof were determined in the same manner as in Example 2 except that the amount by mass of the zinc oxide particle subjected to a surface treatment with a silane coupling agent, used in the undercoat layer coating liquid in Example 2, was changed to 10 parts by mass, and both the amounts by mass of tetrahydrofuran and 1-methoxy-2-propanol were changed to 108 parts by mass. The results are shown in Table 12.

### Example 8

An electrophotographic photosensitive member was produced and the fluctuations in potentials thereof were determined in the same manner as in Example 2 except that the amount by mass of the zinc oxide particle subjected to a surface treatment with a silane coupling agent, used in the undercoat layer coating liquid in Example 2, was changed to 20 parts by mass, and both the amounts by mass of tetrahydrofuran and 1-methoxy-2-propanol were changed to 133 parts by mass. The results are shown in Table 12.

### Example 9

An electrophotographic photosensitive member was produced and the fluctuations in potentials thereof were determined in the same manner as in Example 1 except that the amounts by mass of the crosslinking agent and the resin used in the undercoat layer coating liquid in Example 1 were changed to 15.7 parts by mass and 0 parts by mass, respectively. The results are shown in Table 12.

### Example 10

An electrophotographic photosensitive member was produced and the fluctuations in potentials thereof were determined in the same manner as in Example 1 except that the amounts by mass of the crosslinking agent and the resin used in the undercoat layer coating liquid in Example 1 were changed to 19.8 parts by mass and 0 parts by mass, respectively. The results are shown in Table 12.

### Example 11

An electrophotographic photosensitive member was produced and the fluctuations in potentials thereof were determined in the same manner as in Example 2 except that the butyral resin used in the undercoat layer coating liquid in Example 2 was changed to an acetal resin (trade name: Eslec KS-5, produced by Sekisui Chemical Co., Ltd.). The results are shown in Table 12.

### Example 12

An electrophotographic photosensitive member was produced and the fluctuations in potentials thereof were determined in the same manner as in Example 1 except that the zinc oxide particle subjected to a surface treatment with a silane coupling agent, used in the undercoat layer coating liquid in Example 1, was changed to the following titanium oxide particle subjected to a surface treatment with a silane coupling agent. The results are shown in Table 12.

One hundred parts of a titanium oxide particle (average particle size: 70 nm, specific surface area: 20.5 m²/g, produced by Ishihara Sangyo Kaisha Ltd.) was mixed with a mixed solvent of 900 parts of methanol and 100 parts of water under stirring. As a surface treatment agent, 5 parts of 3-(trimethoxysilyl)propyl acrylate (produced by Tokyo Chemical Industry Co., Ltd.) was added thereto and mixed therewith under stirring for 4 hours. Thereafter, methanol and water were distilled off under reduced pressure, and the resultant was dried at 120° C. for 3 hours to thereby provide a titanium oxide particle subjected to a surface treatment with a silane coupling agent.

### Examples 13 to 22

Each electrophotographic photosensitive member was produced and the fluctuations in potentials thereof were determined in the same manner as in each of Examples 2 to 11 except that the zinc oxide particle used in the undercoat layer coating liquid in each of Examples 2 to 11 was changed to the titanium oxide particle used in Example 12. The results are shown in Table 12.

### Example 23

An electrophotographic photosensitive member was produced and the fluctuations in potentials thereof were determined in the same manner as in Example 1 except that the dispersion liquid used in the undercoat layer coating liquid in Example 1 was prepared as follow. The results are shown in Table 12.

Five parts of the zinc oxide particle subjected to a surface treatment with a silane coupling agent, 10 parts of electron transporting substance (A117), 7.8 parts of a crosslinking agent having a butyletherified methylol group represented by the following formula (9) and 12.7 parts of an alkyd resin (trade name: M-6405-50, produced by DIC Corporation) were added to a mixed solvent of 80 parts of tetrahydrofuran and 80 parts of cyclohexanone.

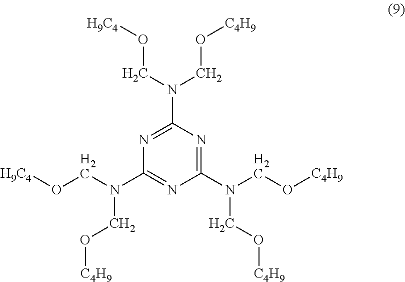

### Example 24

An electrophotographic photosensitive member was produced and the fluctuations in potentials thereof were determined in the same manner as in Example 23 except that the amounts by mass of the crosslinking agent and the resin used in the undercoat layer coating liquid in Example 23 were changed to 9.6 parts by mass and 18.6 parts by mass, respectively, and both the amounts by mass of tetrahydrofuran and cyclohexanone were changed to 92 parts by mass. The results are shown in Table 12.

### Example 25

An electrophotographic photosensitive member was produced and the fluctuations in potentials thereof were determined in the same manner as in Example 23 except that the amounts by mass of the crosslinking agent and the resin used in the undercoat layer coating liquid in Example 23 were changed to 11.1 parts by mass and 23.7 parts by mass, respectively, and both the amounts by mass of tetrahydrofuran and cyclohexanone were changed to 102 parts by mass. The results are shown in Table 12.

### Example 26

An electrophotographic photosensitive member was produced and the fluctuations in potentials thereof were determined in the same manner as in Example 24 except that the amount by mass of the zinc oxide particle subjected to a surface treatment with a silane coupling agent, used in the undercoat layer coating liquid in Example 24, was changed to 2.5 parts by mass, and both the amounts by mass of tetrahydrofuran and cyclohexanone were changed to 86 parts by mass. The results are shown in Table 12.

### Example 27

An electrophotographic photosensitive member was produced and the fluctuations in potentials thereof were determined in the same manner as in Example 24 except that the amount by mass of the zinc oxide particle subjected to a surface treatment with a silane coupling agent, used in the undercoat layer coating liquid in Example 24, was changed to 10 parts by mass, and both the amounts by mass of tetrahydrofuran and cyclohexanone were changed to 105 parts by mass. The results are shown in Table 12.

### Example 28

An electrophotographic photosensitive member was produced and the fluctuations in potentials thereof were determined in the same manner as in Example 24 except that the amount by mass of the zinc oxide particle subjected to a surface treatment with a silane coupling agent, used in the undercoat layer coating liquid in Example 24, was changed to 20 parts by mass, and both the amounts by mass of tetrahydrofuran and cyclohexanone were changed to 130 parts by mass. The results are shown in Table 12.

### Example 29

An electrophotographic photosensitive member was produced and the fluctuations in potentials thereof were determined in the same manner as in Example 23 except that the amounts by mass of the crosslinking agent and the resin used in the undercoat layer coating liquid in Example 23 were changed to 14.2 parts by mass and 0 parts by mass, respectively. The results are shown in Table 12.

### Example 30

An electrophotographic photosensitive member was produced and the fluctuations in potentials thereof were determined in the same manner as in Example 23 except that the amounts by mass of the crosslinking agent and the resin used in the undercoat layer coating liquid in Example 23 were changed to 18.9 parts by mass and 0 parts by mass, respectively. The results are shown in Table 12.

### Examples 31 to 38

Each electrophotographic photosensitive member was produced and the fluctuations in potentials thereof were determined in the same manner as in each of Examples 23 to 30 except that the zinc oxide particle used in the undercoat layer coating liquid in each of Examples 23 to 30 was changed to the titanium oxide particle used in Example 12. The results are shown in Table 12.

### Example 39 to 51

Each electrophotographic photosensitive member was produced and the fluctuations in potentials thereof were determined in the same manner as in Example 2 except that the electron transporting substance having a polymerizable functional group, used in Example 2, was changed to each electron transporting substance having a polymerizable functional group, shown in Tables 12 and 13. The results are shown in Tables 12 and 13.

### Example 52 to 64

Each electrophotographic photosensitive member was produced and the fluctuations in potentials thereof were determined in the same manner as in Example 32 except that the electron transporting substance having a polymerizable functional group, used in Example 32, was changed to each electron transporting substance having a polymerizable functional group, shown in Table 13. The results are shown in Table 13.

### Example 65

An electrophotographic photosensitive member was produced and the fluctuations in potentials thereof were determined in the same manner as in Example 12 except that the dispersion liquid used in the undercoat layer coating liquid in Example 12 was prepared as follows. The results are shown in Table 13.

Five parts of the titanium oxide particle subjected to a surface treatment with a silane coupling agent, 10 parts of electron transporting substance (A120) and 31.8 parts of an oxazoline group-containing polymer (trade name: Epocros WS-700, produced by Nippon Shokubai Co., Ltd.) as a crosslinking agent were added to a mixed solvent of 24.6 parts of water, 113.1 parts of methanol and 4 parts of triethylamine.

### Example 66

An electrophotographic photosensitive member was produced and the fluctuations in potentials thereof were determined in the same manner as in Example 1 expect that an aluminum cylinder having a length of 260.5 mm and a diameter of 30 mm (JIS-A3003, aluminum alloy), subjected to an anodization treatment, was used as a support (electroconductive support). The results are shown in Table 13.

### Example 67

An electrophotographic photosensitive member was produced and the fluctuations in potentials thereof were determined in the same manner as in Example 1 expect that an aluminum cylinder having a length of 260.5 mm and a diameter of 30 mm (JIS-A3003, aluminum alloy), subjected to a cutting/roughening treatment, was used as a support (electroconductive support).

### Example 68

An electrophotographic photosensitive member was produced and the fluctuations in potentials thereof were determined in the same manner as in Example 1 expect that the thickness of the undercoat layer in Example 1 was changed to 3 μm. The results are shown in Table 13.

### Example 69

An electrophotographic photosensitive member was produced and the fluctuations in potentials thereof were determined in the same manner as in Example 1 expect that the undercoat layer coating liquid used in Example 1 was prepared as follows. The results are shown in Table 13.

A titanium oxide particle treated with a dimethylsilicone oil (trade name: JR-405, produced by Tayca) (0.3 parts),

10 parts of electron transporting substance having a polymerizable functional group (A117),
14.2 parts of a crosslinking agent having a block isocyanate group represented by formula (6),
1.5 parts of a butyral resin (trade name: Eslec BX-1, produced by Sekisui Chemical Co., Ltd.), and
0.2 parts of dioctyl tin dilaurate were added to a mixed solvent of 113 parts of tetrahydrofuran and 113 parts of 1-methoxy-2-propanol to prepare a dispersion liquid.

The dispersion liquid was subjected to a dispersion treatment in a vertical sand mill with glass beads having an average particle size of 1.0 mm for 3 hours. After the dispersion treatment, 3 parts of a silicone resin particle (trade name: Tospearl 145, produced by Momentive Performance Materials Inc.) was added to the resulting dispersion liquid and stirred to thereby prepare an undercoat layer coating liquid. The support was dip-coated with the undercoat layer coating liquid, and the resulting coating film was heated and cured at 160° C. for 30 minutes to thereby form an undercoat layer that was a cured film having a thickness of 0.5 μm.

### Example 70

An electrophotographic photosensitive member was produced and the fluctuations in potentials thereof were determined in the same manner as in Example 69 expect that the amount of the titanium oxide in the undercoat layer in Example 69 and the thickness thereof were 0.15 parts and 1 μm, respectively. The results are shown in Table 13.

### Comparative Example 1

An electrophotographic photosensitive member was produced and the fluctuations in potentials thereof were determined in the same manner as in Example 1 expect that the undercoat layer coating liquid used in Example 1 was prepared as follows. The results are shown in Table 13.

One hundred parts of a zinc oxide particle (average particle size: 70 nm, specific surface area: 15 m²/g, produced by Tayca) was mixed with 500 parts of toluene under stirring. As a surface treatment agent, 1.25 parts of N-2-(aminoethyl)-3-aminopropyltrimethoxysilane (trade name: KBM603, produced by Shin-Etsu Chemical Co., Ltd.) was added thereto, and mixed therewith under stirring for 4 hours. Thereafter, toluene was distilled off under reduced pressure, and the resultant was dried at 120° C. for 3 hours to thereby provide a zinc oxide particle subjected to a surface treatment with a silane coupling agent.

One thousand parts of the zinc oxide particle subjected to a surface treatment with the silane coupling agent, 10 parts of an electron transporting substance represented by the following formula (5), 225 parts of the crosslinking agent having the block isocyanate group represented by the formula (6), 250 parts of a butyral resin (trade name: Eslec BM-1) and 2 parts of dioctyl tin dilaurate were added to 5570 parts of methyl ethyl ketone to prepare a dispersion liquid.

The dispersion liquid was subjected to a dispersion treatment in a vertical sand mill with glass beads having an average particle size of 1.0 mm for 4 hours. After the dispersion treatment, 4 parts of a silicone resin particle (trade name: Tospearl 145, produced by Momentive Performance Materials Inc.) was added to 63 parts of the resulting dispersion liquid and stirred to thereby prepare an undercoat layer coating liquid.

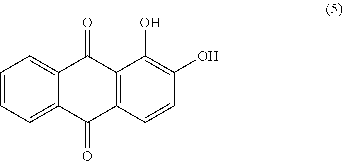 [SMILES: O=C1c2ccccc2C(=O)c2c1ccc(O)c2O]

### Comparative Example 2

An electrophotographic photosensitive member was produced and the fluctuations in potentials thereof were determined in the same manner as in Example 12 expect that the dispersion liquid used in the undercoat layer coating liquid in Example 12 was prepared as follows. The results are shown in Table 13.

Ten parts of a titanium oxide particle subjected to a surface treatment with a silane coupling agent, 1.5 parts of the crosslinking agent having the butyletherified methylol group represented by the formula (9) and 3.8 parts of an alkyd resin (trade name: M-6005-60, produced by DIC Corporation) were added to 11.3 parts of methyl ethyl ketone to prepare a dispersion liquid.

### Comparative Example 3

An electrophotographic photosensitive member was produced and the fluctuations in potentials thereof were determined in the same manner as in Example 12 expect that the undercoat layer coating liquid used in Example 12 was prepared as follows. The results are shown in Table 13.

One hundred parts of a titanium oxide particle (average particle size: 70 nm, specific surface area: 20.5 m²/g, produced by Ishihara Sangyo Kaisha Ltd.) was mixed with a mixed solvent of 900 parts of methanol and 100 parts of water under stirring. As a surface treatment agent, 5 parts of 3-(trimethoxysilyl)propyl acrylate (produced by Tokyo Chemical Industry Co., Ltd.) was added thereto and mixed therewith under stirring for 4 hours. Thereafter, methanol and water were distilled off under reduced pressure, and the resultant was dried at 120° C. for 3 hours to thereby provide a titanium oxide particle subjected to a surface treatment with a silane coupling agent.

Twenty-five parts of the titanium oxide particle subjected to a surface treatment with a silane coupling agent, 10 parts of an electron transporting substance represented by the following formula (11) and 50 parts of the crosslinking agent having the butyletherified methylol group as a polymerizable functional group represented by formula (9) were added to 190 parts of tetrahydrofuran to prepare a dispersion liquid. The dispersion liquid was subjected to a dispersion treatment in a vertical sand mill with glass beads having an average particle size of 1.0 mm for 4 hours to thereby prepare an undercoat layer coating liquid.

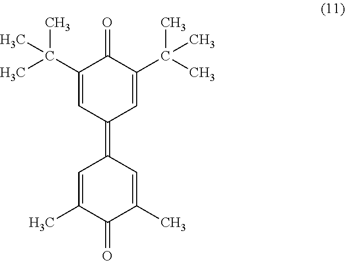 [SMILES: CC1=CC(=C2C=C(C(C)(C)C)C(=O)C(C(C)(C)C)=C2)C=C(C)C1=O]

TABLE 12

| | Electron | | | | | | | |
|---|---|---|---|---|---|---|---|---|
| | transporting | Crosslinking | Metal oxide | | Mass ratio of electron transporting substance | | Fluctuation in potential/V | |
| Example | substance | agent | particle | Resin | to Metal oxide particle | to solid content | ΔVd | ΔVl |
| 1 | A117 | Formula (6) | Zinc oxide | Butyral resin | 2.0 | 29.5% by mass | 3 | −6 |
| 2 | A117 | Formula (6) | Zinc oxide | Butyral resin | 2.0 | 26.3% by mass | 3 | −6 |
| 3 | A117 | Formula (6) | Zinc oxide | Butyral resin | 2.0 | 23.8% by mass | 4 | −7 |
| 4 | A117 | Formula (6) | Zinc oxide | Butyral resin | 2.0 | 21.6% by mass | 4 | −9 |
| 5 | A117 | Formula (6) | Zinc oxide | Butyral resin | 2.0 | 19.9% by mass | 5 | −10 |
| 6 | A117 | Formula (6) | Zinc oxide | Butyral resin | 4.0 | 28.2% by mass | 2 | −5 |
| 7 | A117 | Formula (6) | Zinc oxide | Butyral resin | 1.0 | 23.3% by mass | 7 | −8 |
| 8 | A117 | Formula (6) | Zinc oxide | Butyral resin | 0.5 | 18.9% by mass | 10 | −12 |
| 9 | A117 | Formula (6) | Zinc oxide | None | 2.0 | 29.5% by mass | 4 | −7 |
| 10 | A117 | Formula (6) | Zinc oxide | None | 2.0 | 26.3% by mass | 4 | −8 |
| 11 | A117 | Formula (6) | Zinc oxide | Acetal resin | 2.0 | 26.3% by mass | 3 | −6 |
| 12 | A117 | Formula (6) | Titanium oxide | Butyral resin | 2.0 | 29.5% by mass | 3 | −7 |
| 13 | A117 | Formula (6) | Titanium oxide | Butyral resin | 2.0 | 26.3% by mass | 3 | −7 |
| 14 | A117 | Formula (6) | Titanium oxide | Butyral resin | 2.0 | 23.8% by mass | 4 | −8 |
| 15 | A117 | Formula (6) | Titanium oxide | Butyral resin | 2.0 | 21.6% by mass | 4 | −10 |
| 16 | A117 | Formula (6) | Titanium oxide | Butyral resin | 2.0 | 19.9% by mass | 5 | −11 |
| 17 | A117 | Formula (6) | Titanium oxide | Butyral resin | 4.0 | 28.2% by mass | 2 | −6 |
| 18 | A117 | Formula (6) | Titanium oxide | Butyral resin | 1.0 | 23.3% by mass | 7 | −9 |
| 19 | A117 | Formula (6) | Titanium oxide | Butyral resin | 0.5 | 18.9% by mass | 10 | −13 |
| 20 | A117 | Formula (6) | Titanium oxide | None | 2.0 | 29.5% by mass | 4 | −8 |
| 21 | A117 | Formula (6) | Titanium oxide | None | 2.0 | 26.3% by mass | 4 | −9 |
| 22 | A117 | Formula (6) | Titanium oxide | Acetal resin | 2.0 | 26.3% by mass | 3 | −7 |
| 23 | A117 | Formula (9) | Zinc oxide | Alkyd resin | 2.0 | 26.0% by mass | 3 | −6 |
| 24 | A117 | Formula (9) | Zinc oxide | Alkyd resin | 2.0 | 21.6% by mass | 3 | −6 |
| 25 | A117 | Formula (9) | Zinc oxide | Alkyd resin | 2.0 | 18.9% by mass | 4 | −7 |
| 26 | A117 | Formula (9) | Zinc oxide | Alkyd resin | 4.0 | 28.2% by mass | 2 | −5 |
| 27 | A117 | Formula (9) | Zinc oxide | Alkyd resin | 1.0 | 23.3% by mass | 7 | −8 |
| 28 | A117 | Formula (9) | Zinc oxide | Alkyd resin | 0.5 | 18.9% by mass | 10 | −12 |
| 29 | A117 | Formula (9) | Zinc oxide | None | 2.0 | 29.5% by mass | 4 | −7 |
| 30 | A117 | Formula (9) | Zinc oxide | None | 2.0 | 26.3% by mass | 4 | −8 |
| 31 | A117 | Formula (9) | Titanium oxide | Alkyd resin | 2.0 | 29.5% by mass | 3 | −7 |
| 32 | A117 | Formula (9) | Titanium oxide | Alkyd resin | 2.0 | 26.3% by mass | 3 | −7 |
| 33 | A117 | Formula (9) | Titanium oxide | Alkyd resin | 2.0 | 23.8% by mass | 4 | −8 |
| 34 | A117 | Formula (9) | Titanium oxide | Alkyd resin | 4.0 | 28.2% by mass | 2 | −6 |
| 35 | A117 | Formula (9) | Titanium oxide | Alkyd resin | 1.0 | 23.3% by mass | 7 | −9 |
| 36 | A117 | Formula (9) | Titanium oxide | Alkyd resin | 0.5 | 18.9% by mass | 10 | −13 |
| 37 | A117 | Formula (9) | Titanium oxide | None | 2.0 | 29.5% by mass | 4 | −8 |
| 38 | A117 | Formula (9) | Titanium oxide | None | 2.0 | 26.3% by mass | 4 | −9 |
| 39 | A109 | Formula (6) | Zinc oxide | Butyral resin | 2.0 | 26.3% by mass | 3 | −6 |

In table 12, “solid content” represents “total solid content”.

TABLE 13

| | Electron | | | | | | | |
|---|---|---|---|---|---|---|---|---|
| | transporting | Crosslinking | Metal oxide | | Mass ratio of electron transporting substance | | Fluctuation in potential/V | |
| Example | substance | agent | particle | Resin | to Metal oxide particle | to solid content | ΔVd | ΔVl |
| 40 | A114 | Formula (6) | Zinc oxide | Butyral resin | 2.0 | 26.3% by mass | 3 | −6 |
| 41 | A104 | Formula (6) | Zinc oxide | Butyral resin | 2.0 | 26.3% by mass | 3 | −6 |
| 42 | A205 | Formula (6) | Zinc oxide | Butyral resin | 2.0 | 26.3% by mass | 3 | −10 |
| 43 | A305 | Formula (6) | Zinc oxide | Butyral resin | 2.0 | 26.3% by mass | 3 | −10 |
| 44 | A402 | Formula (6) | Zinc oxide | Butyral resin | 2.0 | 26.3% by mass | 3 | −9 |
| 45 | A502 | Formula (6) | Zinc oxide | Butyral resin | 2.0 | 26.3% by mass | 3 | −9 |
| 46 | A601 | Formula (6) | Zinc oxide | Butyral resin | 2.0 | 26.3% by mass | 3 | −9 |
| 47 | A703 | Formula (6) | Zinc oxide | Butyral resin | 2.0 | 26.3% by mass | 3 | −9 |
| 48 | A801 | Formula (6) | Zinc oxide | Butyral resin | 2.0 | 26.3% by mass | 3 | −9 |
| 49 | A902 | Formula (6) | Zinc oxide | Butyral resin | 2.0 | 26.3% by mass | 3 | −10 |
| 50 | A1004 | Formula (6) | Zinc oxide | Butyral resin | 2.0 | 26.3% by mass | 3 | −9 |
| 51 | A1102 | Formula (6) | Zinc oxide | Butyral resin | 2.0 | 26.3% by mass | 3 | −9 |
| 52 | A109 | Formula (9) | Titanium oxide | Alkyd resin | 2.0 | 26.3% by mass | 3 | −7 |
| 53 | A114 | Formula (9) | Titanium oxide | Alkyd resin | 2.0 | 26.3% by mass | 3 | −7 |
| 54 | A104 | Formula (9) | Titanium oxide | Alkyd resin | 2.0 | 26.3% by mass | 3 | −7 |
| 55 | A205 | Formula (9) | Titanium oxide | Alkyd resin | 2.0 | 26.3% by mass | 3 | −11 |
| 56 | A305 | Formula (9) | Titanium oxide | Alkyd resin | 2.0 | 26.3% by mass | 3 | −11 |
| 57 | A402 | Formula (9) | Titanium oxide | Alkyd resin | 2.0 | 26.3% by mass | 3 | −10 |
| 58 | A502 | Formula (9) | Titanium oxide | Alkyd resin | 2.0 | 26.3% by mass | 3 | −10 |
| 59 | A601 | Formula (9) | Titanium oxide | Alkyd resin | 2.0 | 26.3% by mass | 3 | −10 |
| 60 | A703 | Formula (9) | Titanium oxide | Alkyd resin | 2.0 | 26.3% by mass | 3 | −10 |
| 61 | A801 | Formula (9) | Titanium oxide | Alkyd resin | 2.0 | 26.3% by mass | 3 | −10 |
| 62 | A902 | Formula (9) | Titanium oxide | Alkyd resin | 2.0 | 26.3% by mass | 3 | −11 |
| 63 | A1004 | Formula (9) | Titanium oxide | Alkyd resin | 2.0 | 26.3% by mass | 3 | −10 |
| 64 | A1102 | Formula (9) | Titanium oxide | Alkyd resin | 2.0 | 26.3% by mass | 3 | −10 |
| 65 | A120 | WS-700 | Titanium oxide | None | 2.0 | 20.1% by mass | 6 | −12 |
| 66 | A117 | Formula (6) | Zinc oxide | Butyral resin | 2.0 | 29.5% by mass | 4 | −7 |
| 67 | A117 | Formula (6) | Zinc oxide | Butyral resin | 2.0 | 29.5% by mass | 3 | −11 |
| 68 | A117 | Formula (6) | Zinc oxide | Butyral resin | 2.0 | 29.5% by mass | 4 | −6 |
| 69 | A117 | Formula (6) | Titanium oxide | Butyral resin | 33 | 34.2% by mass | 3 | −6 |
| 70 | A117 | Formula (6) | Titanium oxide | Butyral resin | 67 | 34.4% by mass | 3 | −5 |

| | Electron | | | | | | | |
|---|---|---|---|---|---|---|---|---|
| Comparative | transporting | Crosslinking | Metal oxide | | Mass ratio of electron transporting substance | | Fluctuation in potential/V | |
| Example | substance | agent | particle | Resin | to Metal oxide particle | in Composition | ΔVd | ΔVl |
| 1 | Formula (5) | Formula (6) | Zinc oxide | Butyral resin | 0.01 | 0.6% by mass | 15 | −20 |
| 2 | None | Formula (9) | Titanium oxide | Alkyd resin | 0.00 | 0.0% by mass | 17 | −23 |
| 3 | Formula (11) | Formula (9) | Titanium oxide | None | 0.40 | 16.7% by mass | 11 | −25 |

In table 13, “solid content” represents “total solid content”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-270564, filed Dec. 26, 2013, and Japanese Patent Application No. 2014-247188, filed Dec. 5, 2014 which are hereby incorporated by reference herein in their entirety.

What is claimed is:

1. An electrophotographic photosensitive member comprising:
a support;
an undercoat layer formed on the support;
a charge generating layer formed directly on the undercoat layer; and
a hole transporting layer formed on the charge generating layer;
wherein the undercoat layer comprises:
a polymerized product of a composition comprising an electron transporting substance having a polymerizable functional group, and a crosslinking agent;
a metal oxide particle; and
wherein a mass ratio of the electron transporting substance in the composition to the metal oxide particle is 0.5 or more.

2. The electrophotographic photosensitive member according to claim 1, wherein the polymerizable functional group of the electron transporting substance is a hydroxy group or a carboxyl group.

3. The electrophotographic photosensitive member according to claim 1, wherein the crosslinking agent is
an isocyanate compound having an isocyanate group or a block isocyanate group, or
an amine compound having an alkylol group or an alkyletherified alkylol group.

4. The electrophotographic photosensitive member according to claim 1, wherein a content of the electron transporting substance in the composition is 20% by mass or more based on the total solid content of an undercoat layer coating liquid.

5. The electrophotographic photosensitive member according to claim 1, wherein the mass ratio of the electron transporting substance in the composition to the metal oxide particle is 0.5 or more and 100 or less.

6. The electrophotographic photosensitive member according to claim 1, wherein the mass ratio of the electron transporting substance in the composition to the metal oxide particle is 1.0 or more.

7. The electrophotographic photosensitive member according to claim 5, wherein the mass ratio of the electron transporting substance in the composition to the metal oxide particle is 11 or more and 100 or less.

8. The electrophotographic photosensitive member according to claim 1, wherein the composition further comprises a thermoplastic resin having a polymerizable functional group.

9. The electrophotographic photosensitive member according to claim 8, wherein the polymerizable functional group of the thermoplastic resin is a hydroxy group, a thiol group, an amino group, a carboxyl group or a methoxy group.

10. A process cartridge integrally supporting the electrophotographic photosensitive member according to claim 1 and at least one unit selected from the group consisting of a charging unit, a developing unit and a cleaning unit, the process cartridge being attachable to and detachable from a main body of an electrophotographic apparatus.

11. An electrophotographic apparatus comprising the electrophotographic photosensitive member according to claim 1, a charging unit, an exposing unit, a developing unit and a transfer unit.
